(19) United States
(12) Patent Application Publication
(10) Pub. No.: US 2026/0324618 A1
(43) Pub. Date: Oct. 22, 2026

(54) WEED CONTROL METHOD AND CORRESPONDING WEED CONTROL DEVICE

(71) Applicants: CENTRE NATIONAL DE LA RECHERCHE SCIENTIFIQUE, Paris (FR); UNIVERSITE PARIS-SACLAY, SAINT-AUBIN (FR)

(72) Inventors: Olivier SIMON, Villebon Sur Yvette (FR); Jacques ROBERT, Saint-Remy Les Chevreuse (FR); Tiberiu MINEA, Saint-Remy Les Chevreuse (FR); Charles BALLAGE, Bur Sur Yvette (FR)

(21) Appl. No.: 18/993,186

(22) PCT Filed: Jul. 11, 2023
(86) PCT No.: PCT/EP2023/069116

§ 371 Date: Jan. 10, 2025

(30) Foreign Application Priority Data
Jul. 12, 2022 (FR) FR2207158

(51) Int. Cl. A01M 21/04

(52) U.S. Cl. CPC A01M 21/04

(57) ABSTRACT

A weed control method including generating a plasma from a plasma gas and exposing unwanted plants to the plasma in order to eliminate these unwanted plants.

The present invention relates to the field of weeding, i.e. the elimination of unwanted plants, also referred to as adventitious plants or weeds.

In the agricultural field, it is important to seek to eliminate unwanted plants since these capture some of the water necessary for growth of the planted seeds, and shelter insects that are detrimental to the plants that it is wished to see grow.

It may be necessary to carry out full weeding of a field before planting, or a partial weeding of a field after planting, between rows of plantings, during growth thereof.

In the urban field or for public infrastructures (paths, roads, railways, aerodromes, etc) unwanted plants must be eliminated in order not to interfere with traffic or not to contribute to degradation of infrastructures.

It is possible to carry out chemical weeding using an herbicidal chemical product, such as glyphosate.

However, herbicidal chemical products have major drawbacks, such as lasting contamination of soils, which may also contaminate the subsoils, and therefore the water of the water table. In the long run, intensive use thereof makes the soils more and more resistant to the action thereof. Furthermore, glyphosate is now recognised as potentially carcinogenic for humans and carcinogenic for animals.

Other nonchemical weeding methods are possible, such as thermal weeding, electrical weeding, infrared-radiation weeding, ultraviolet-radiation weeding, microwave weeding or hot-water weeding.

Thermal weeding (or “pyroweeding”) is a weeding technique that has recourse solely to heat for lyophilising and ultimately killing the unwanted plants by thermal shock. It consists in applying an intense heat to the unwanted plants to kill them, by bursting their tissues so that they then desiccate in a few days. Thermal weeding can be implemented using heating elements using electricity or gas to generate heat.

The use of thermal weeding in agriculture is implemented for example by means of thermal radiators functioning on gas, which requires transporting one or more gas bottles.

Electrical weeding consists in generating electric arcs that can reach the unwanted plants and damage them because of the electric current that passes through them.

Infrared-radiation weeding and ultraviolet-radiation weeding consist in subjecting the unwanted plants to, respectively, infrared radiation and ultraviolet radiation. Infrared radiation weeding and ultraviolet-radiation weeding can be combined.

Infrared radiation can heat the roots of the unwanted plants and thus disturb the functions thereof. Ultraviolet radiation can damage the unwanted plants because of the heating of the foliage of the unwanted plants following absorption of the ultraviolet radiation by the vegetable tissues of the undesirable plants.

Microwave weeding consists in sending microwaves into the ground in order to damage the roots of unwanted plants.

Weeding by hot water consists in spraying liquid hot water or hot steam onto the unwanted plants.

One of the aims of the invention is to propose a weeding method that is effective and easy to implement.

For this purpose, the invention proposes a weeding method comprising generating a plasma from a plasmagenic gas and exposing unwanted plants to the plasma to eliminate these unwanted plants.

A plasma can be produced easily, for example using the ambient air as gas for generating the plasma, which avoids having to transport a reserve of gas.

Using a plasma combines the effects of other weeding methods, namely thermal effects (heat), chemical effects (formation of active species such as ozone), and radiating effects (emission of UV light, emission of infrared light). Using a plasma therefore enables effective weeding.

In particular embodiments, the weeding method comprises one or more of the following optional features, taken individually or according to all technically possible combinations:
the plasmagenic gas is air;
the plasmagenic gas is compressed;
the generation of a plasma comprises generating at least one plasma jet;
each plasma jet is in the form of a column or a curtain;
it comprises generating several plasma jets spaced apart from each other in a distribution direction;
the plasma jets are spaced apart uniformly, with a constant pitch between the plasma jets in the distribution direction;
it comprises moving the plasma jets along plantation rows extending in a plantation direction, the distribution direction being perpendicular to the plantation direction, each plasma jet being located facing an inter-row of the plantation;
it comprises generating at least one plasma jet by ionisation of the plasmagenic gas by means of microwaves;
generating at least one plasma jet comprises generating microwaves in an elongate waveguide between a first end designed to receive the microwaves and a closed second end, and circulating a flow of plasmagenic gas in one or more passages passing through the waveguide transversely, a respective plasma jet being formed at the exit of each passage;
each passage is located at a distance from the second end of the waveguide tube that is substantially equal to λ/4+N*λ/2 where λ is the wavelength of the microwaves in the guide and N is a natural integer number equal to or greater than zero;
a plurality of waveguides are connected to respective exit arms of a branched power divider by means of which the waveguides receive the microwaves;
at least one plasma jet is generated by discharge, in particular by bare-electrode discharge, by single dielectric barrier discharge or by double dielectric barrier discharge;
it comprises generating a plasma by ionising a layer of air located above the ground;
ionisation is implemented by means of a power electrode positioned above the ground, a dielectric layer being located under the power electrode, by applying a voltage between the power electrode and the ground.

The invention also relates to a weeding device comprising a plasma-generation system configured to generate a plasma from a plasmagenic gas.

In particular embodiments, the weeding device comprises one or more of the following optional features, taken individually or according to all technically possible combinations:
the plasmagenic gas is air;
the plasmagenic gas is compressed;
it is configured to generate at least one plasma jet, each plasma jet being for example in the form of a column or a curtain;
it is configured to generate a plurality of plasma jets spaced apart from each other in a distribution direction;
the plasma jets are spaced apart uniformly, with a constant pitch between the plasma jets in the distribution direction;
it is configured to generate at least one plasma jet by ionisation of the plasmagenic gas by means of microwaves;
it is configured to generate at least one plasma jet from microwaves, comprising a microwave generator configured to generate microwaves in at least one elongate waveguide between a first end designed to receive the microwaves and a closed second end, each waveguide having at least one passage passing through the waveguide transversely, and a supply device configured to supply each passage with a flow of plasmagenic gas for generating a respective plasma jet at the exit of each passage when the microwave generator generates microwaves in the waveguide;
each passage of each waveguide is located at a distance from the second end of the waveguide that is substantially equal to λ/4+N*λ/2 where λ is the wavelength of the microwaves in the guide and N is a natural integer number equal to or greater than zero;
a plurality of waveguides are connected to respective exit branches of a branched power divider by means of which the waveguides receive the microwaves;
it is configured to generate at least one plasma jet by discharge, in particular by bare-electrode discharge, by single dielectric barrier discharge or by double dielectric barrier discharge;
it is configured to generate a plasma by ionising a layer of air located above the ground;
ionisation is implemented by means of a power electrode positioned above the ground, a dielectric layer being located under the power electrode, by applying a voltage between the power electrode and the ground.

The invention and the advantages thereof will be understood better from the reading of the following description, given solely by way of non-limitative example, and made with reference to the accompanying drawings, on which:

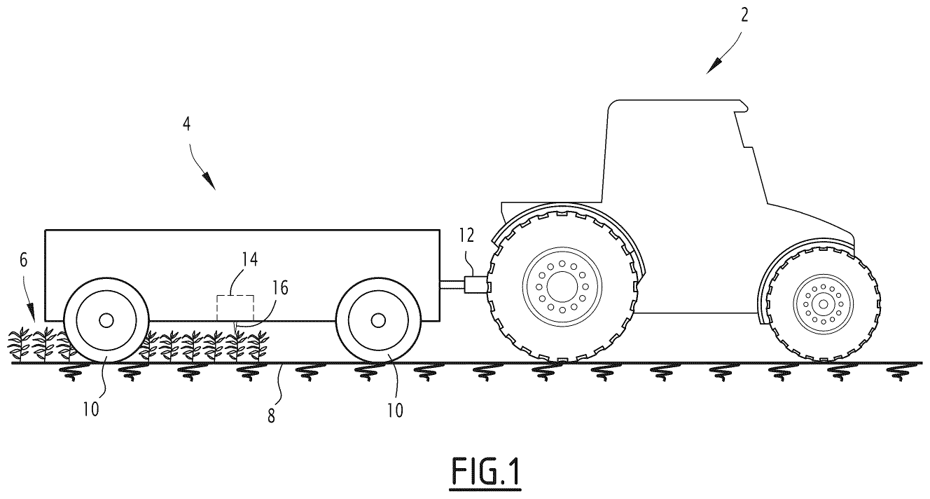

FIG. 1 is a schematic side view of a tractor equipped with a weeding device configured to produce a plasma for implementing a plasma weeding method;

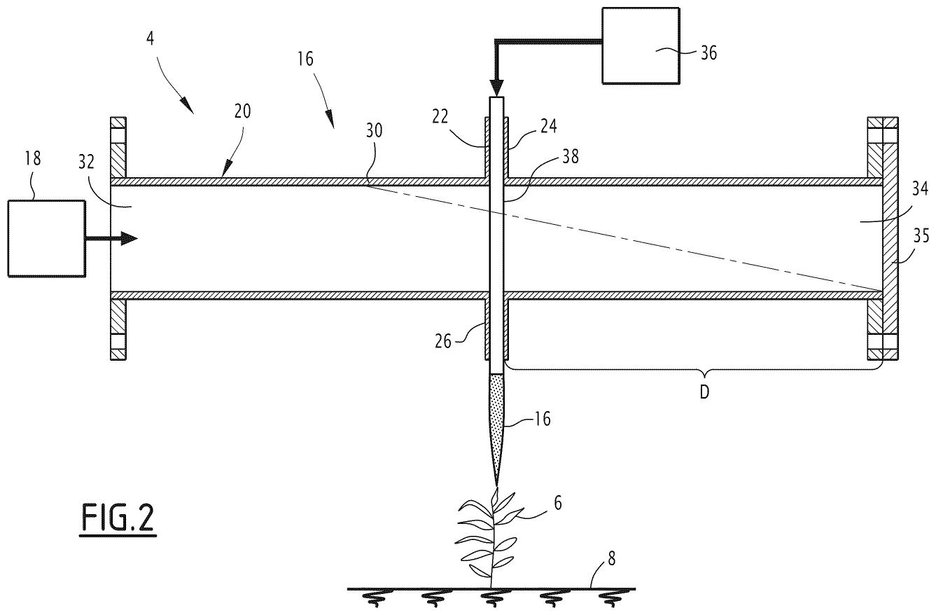

FIG. 2 is a schematic view in cross section of a plasma generation system using microwaves for generating a plasma jet;

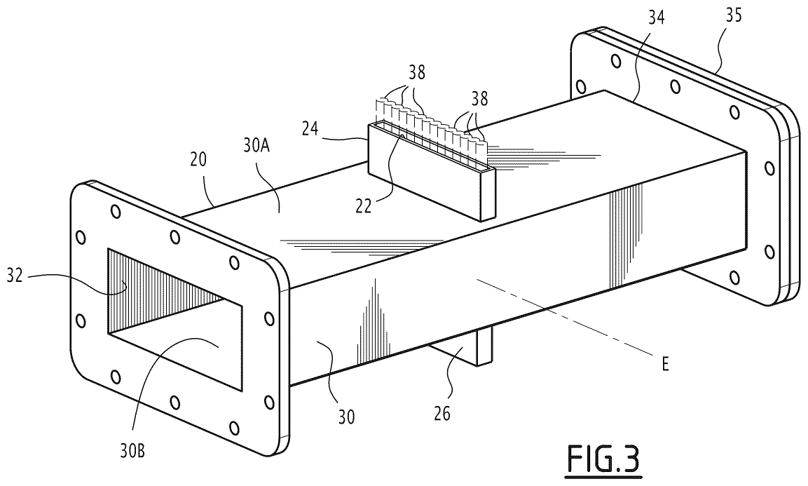

FIG. 3 is a perspective view of a waveguide of the plasma generation system of FIG. 2;

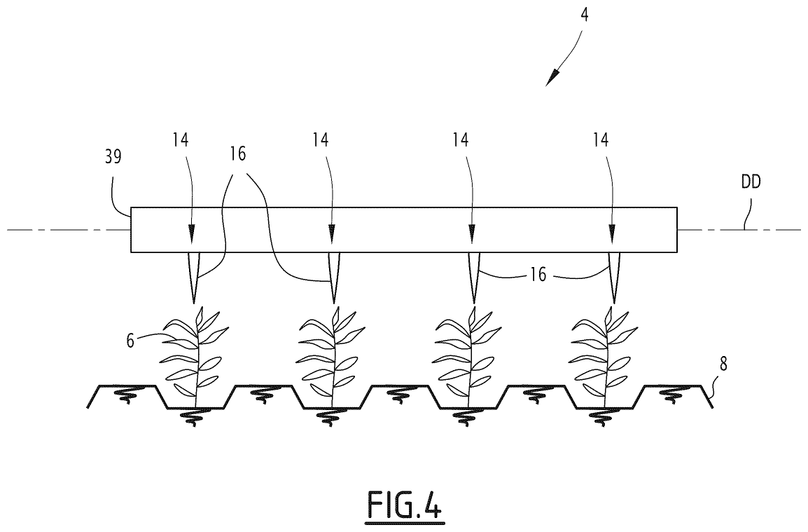

FIG. 4 is a schematic plan view of a plasma generation system configured to generate a plurality of plasma jets simultaneously;

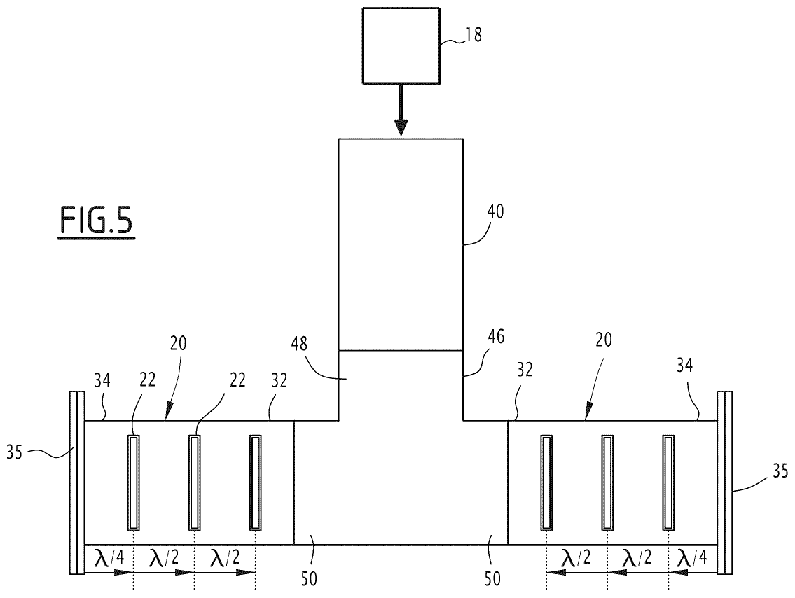

FIG. 5 is a schematic plan view of a plasma generation system configured to generate a plurality of plasma jets simultaneously using microwaves;

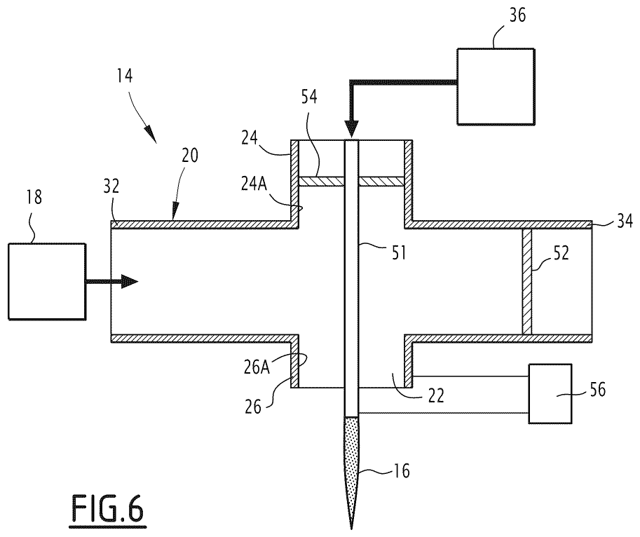

FIG. 6 is a schematic view in cross section of a torch plasma generation system using microwaves for generating a plasma jet;

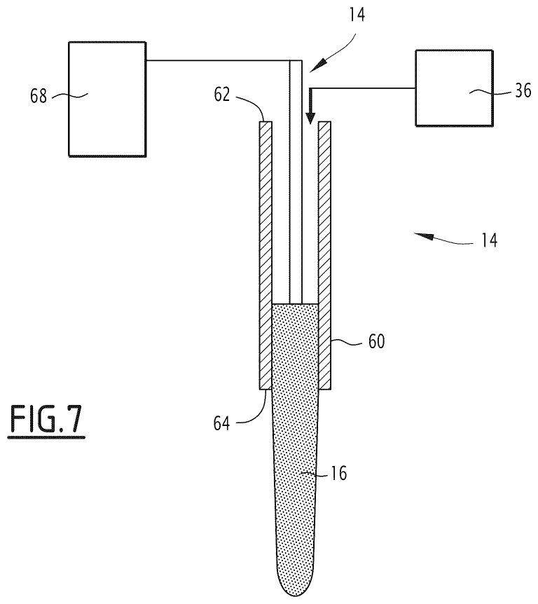

FIG. 7 is a schematic view in cross section of a plasma generation system using electrodes for generating a plasma jet;

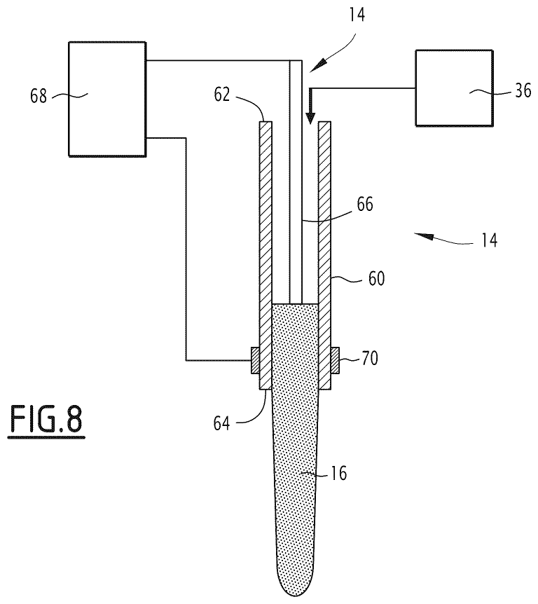

FIG. 8 is a schematic view in cross section of a plasma generation system using electrodes for generating a plasma jet;

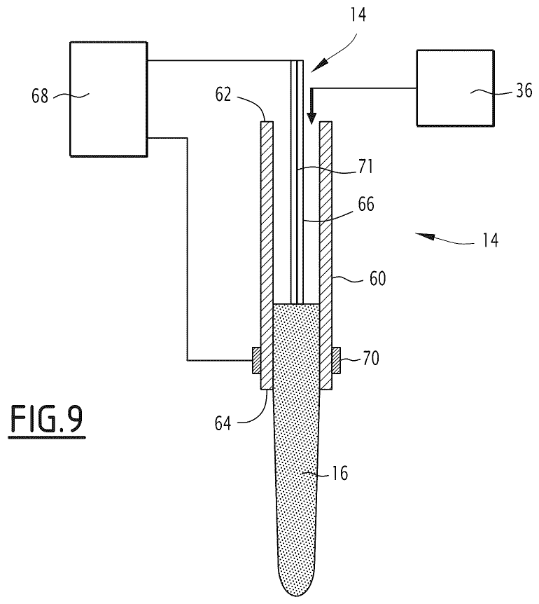

FIG. 9 is a schematic view in cross section of a plasma generation system using electrodes for generating a plasma jet;

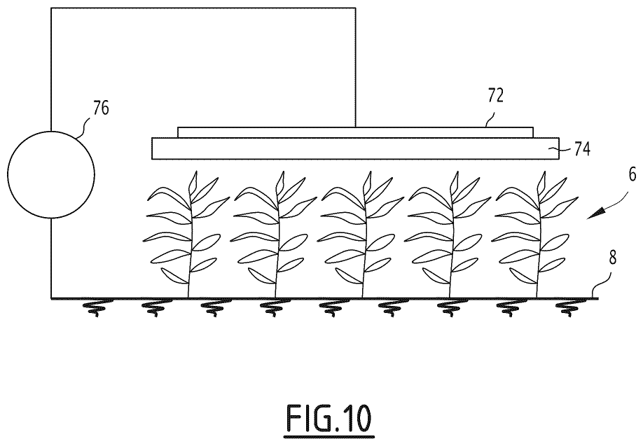

FIG. 10 is a schematic view in cross section of a plasma generation system using an electrode for generating a plasma in a layer of air located between the electrode and the ground.

As illustrated on FIG. 1, a vehicle 2 is equipped with a weeding device 4 configured to eliminate unwanted plants 6 growing on the ground 8 using a weeding method comprising generating a plasma from a plasmagenic gas and exposing unwanted plants to the plasma to eliminate these unwanted plants.

The plasma is a gas ionised by an addition of energy, in particular a gas ionised under the action of an electric field and/or an electromagnetic field, such as an electromagnetic field generated by laser or by other electrical generators (DC, AC, radio frequency, microwave, pulsed, etc).

The plasmagenic gas is for example and not exclusively air. Using air as a plasmagenic gas avoids having to use a reserve of plasmagenic gas. The air necessary for generating the plasma can be taken from the environment and simply compressed by means of a compressor.

The ground 8 is for example the ground of a field intended for cultivating plants. In a variant, the ground 8 is a road, a railway or the like.

The vehicle 2 is for example a tractor intended for implementing agricultural work, in particular in fields. In a variant, the vehicle 2 is a road vehicle, a rail vehicle or the like.

The weeding device 4 comprises for example an axle 10, here two axles 10, and a coupling device 12 for coupling the weeding device 4 to the vehicle 2 so that the weeding device is pulled by the tractor 2.

In a variant, the weeding device 4 is for example configured to be mounted on the vehicle 2, and in particular suspended from the vehicle 2. Such a weeding device 4 is for example mounted or suspended at the rear of the vehicle 2, at the front of the vehicle 2 or under the vehicle 2.

In another variant, the weeding device can be secured to the vehicle (if integrated during the design of the latter).

The weeding device 4 has at least one plasma-generation system 14 configured to generate a plasma for eliminating unwanted plants 6 growing on the ground 8.

In particular, the plasma-generation system 14 is configured to generate one or more plasma jets 16.

The weeding device 4 is preferably configured, when it equips the vehicle 2, to be located above the ground 8 so that the plasma-generation system 14 generates one or more plasma jets 14 directed towards the ground 8 to eliminate the unwanted plants 6 growing on the ground 8.

The weeding device 4 configured to equip the vehicle 2, being for example towed by the vehicle 2 or mounted on the vehicle 2, makes it possible to quickly and effectively treat large surfaces, such as a field, a road or a railway.

Generating one or more plasma jets 16 allows targeted elimination of the unwanted plants, for example by eliminating unwanted plants located between plantation rows, also referred to as “inter-row” adventitious plants.

Advantageously, the plasma-generation system 14 is configured to use air as a plasmagenic gas, i.e. for generating a plasma from air, in particular air taken from the environment of the plasma-generation system 14, and able to be compressed by means of a compressor for example.

Using air as a plasmagenic gas, in particular for generating the plasma jet or jets, makes it possible to take the air from the environment and avoids transporting a reserve of gas. It advantageously simplifies the system, avoiding the time taken for changing reserves of gas (for other gases) and reducing the risk of accident. In addition, it is the least expensive of the gases.

As illustrated on FIGS. 2 and 3, a plasma-generation system 14 is configured to generate at least one plasma jet 16 using microwaves for ionising the gas.

The plasma-generation system 14 comprises at least one microwave generator 18 configured to generate microwaves and at least one waveguide 20 configured to guide the microwaves generated by the microwave generator or generators 18, each waveguide 20 having a passage 22 passing through the waveguide 20 and having an entry 24 for receiving the flow of plasmagenic gas and an exit 26 at which the flow of plasmagenic gas is transformed into a plasma jet 16.

Each waveguide 20 is tubular. It comprises a lateral wall 30 and has a first end 32 designed to receive the microwaves and a closed second end 34. Each waveguide 20 is preferably rectilinear between its first end 32 and its second end 34. The lateral wall 30 is preferably metal.

Each waveguide 20 extends longitudinally between its first end 32 and its second end 34 and, preferably, each passage 22 of the waveguide 20 extends transversely across the waveguide 20.

The entry 24 and the exit 26 of each passage 22 are for example defined by openings provided in the lateral wall 30 of the waveguide 20 and located facing each other.

The entry 24 and the exit 26 are defined by openings provided in the lateral wall 30 of the waveguide 20, being located at the same point along the waveguide 20.

Preferably, the waveguide 20 has a rectangular cross-section (FIG. 3), so that the lateral wall 30 has two first opposite faces 30A and two second opposite faces 30B.

The entry 24 is provided in one from the two first opposite faces 30A and the exit 26 is provided in the others from the two first opposite faces 30A, being located facing the entry 24.

The second end 34 is for example closed by a bottom 35, which is preferably metal. The bottom 36 is for example a plate, in particular a metal plate.

In a variant, as illustrated in dot-and-dash lines on FIG. 3, the waveguide 20 has for example a bevel shape in proximity to its second end 34, the cross section of the waveguide 20 decreasing gradually to its second end 34, which terminates in a point.

Preferably, the length of the waveguide 20 taken between the first end 32 and the second end 34 is equal to M*λ where λ is the wavelength of the microwaves in the guide and M is a natural integer number equal to or greater than 1.

Preferably, the entry 24 and the exit 26 of each passage 22 are provided at a distance D from the second end 34 of the waveguide 20 that is substantially equal to λ/4+N*λ/2 where λ is the wavelength of the microwaves in the guide and N is a natural integer number equal to or greater than zero.

These locations located along the waveguide 20 at such distances from the closed second end 34 of the waveguide 20 are those where the energy of the microwaves is the strongest.

In one example embodiment, a plurality of passages 22 are provided along the waveguide 20.

Advantageously, as illustrated on FIG. 3, the exit 26 of each passage 22 has an elongate shape in an elongation direction E. This makes it possible to generate an elongate-shaped plasma jet 16. The plasma jet 16 is in the form of a blade elongated in the elongation direction E, as illustrated in broken lines on FIG. 3.

Preferably, in this case, the entry 24 also has an elongate shape in the elongation direction E.

In particular, the entry 24 has the same form and the same dimensions as the exit 26. This allows an identical speed of flow of the gas flow at the entry 24 and the exit 26 of the passage 22.

Preferably, the plasma-generation system 14 is configured to supply each passage 20 with compressed plasmagenic gas, in particular to supply each passage 20 with compressed air.

The plasma-generation system 14 comprises a gas-supply device 36 configured to supply compressed plasmagenic gas.

The gas-supply device 36 is for example a source of compressed gas or a compressor.

In particular, the gas-supply device 36 is for example an air compressor configured to supply each passage 22 with compressed air, preferably by taking the air from the environment of the weeding device 4. In a variant, the gas-supply device 36 comprises a reservoir of compressed plasmagenic gas.

Optionally, as illustrated on FIG. 2, the plasma-generation system 14 comprises, in each passage 22, at least one channelling pipe 38, each pipe extending in the passage 22 from the entry 24 to the exit 26.

Each channelling pipe 38 makes it possible to channel the flow of plasmagenic gas between the entry 24 and the exit 26, without the plasmagenic gas circulating in the waveguide 20. The plasmagenic gas is in particular confined in the region where the energy of the microwaves is the strongest.

The plasma-generation system 14 comprises, for example, in at least one passage 22 or in each passage 22, a single channelling pipe 38 the cross section of which corresponds to that of the entry 24 and of the exit 26. In operation, the plasma jet 16 is generated at the exit of the channelling pipe 38.

In a variant, the plasma-generation system 14 comprises, for example, in at least one passage 22 or in each passage 22, a plurality of channelling pipes 38 disposed side by side.

In operation, an elementary plasma jet is generated at the exit of each channelling pipe 38, the elementary plasma jets defining the plasma jet 16.

The channelling pipes 38 are for example pipes with a circular cross-section disposed side by side to take together the elongate shape of the entry 24 and of the exit 26 of the passage 22.

In operation, the microwave generator 18 generates microwaves propagating in the waveguide 20, and the gas-supply device supplies each passage 22 with gas, in particular with air. In passing through the passage 22, the gas is ionised by the microwaves propagating in the waveguide 20, and a plasma jet 16 is thus generated at the exit 26 of each passage 22. The plasma jet 16 damages the unwanted plants located in proximity to the plasma jet 16.

Advantageously, as illustrated on FIG. 4, a weeding device 4 comprises a plasma-generation system 14 and is configured to generate simultaneously a plurality of plasma jets 16.

Preferably, the plasma jets 16 are distributed along a distribution direction DD while being spaced apart from one another, preferably uniformly, i.e. with a constant pitch between the plasma jets 16.

Such an arrangement of the plasma jet 16 makes it possible for example to simultaneously treat several spaces between rows of plantings (or “inter-row”) extending parallel, the weeding device 4 being disposed so that the distribution direction DD is perpendicular to the planting rows and so that each plasma jet 16 is located in an inter-row, the weeding device 4 being moved along the planting rows.

In one example embodiment, a plurality of plasma jets 16 distributed along a distribution direction DD are generated by means of microwaves, preferably generated by a single microwave generator 18.

To do this, the plasma-generation system 14 comprises for example at least one waveguide 20 provided with a plurality of passages 20 disposed along this same waveguide 20.

In such a case, the separation between each plasma jet 16 and the following one is approximately λ/2, λ being the wavelength in the guide of the microwaves generated by the microwave generator.

Each waveguide 20 has for example one passage 22, two passages 22, three passages 22, four passages 22 or more.

In a variant or in an optional supplement, the plasma-generation system 14 comprises a plurality of waveguides 20 receiving microwaves generated by one and the same microwave generator 18.

The plasma-generation system 14 of FIG. 5 is similar to the one in FIG. 3 while being configured to simultaneously generate a plurality of plasma jet 16 by means of a single microwave generator 18, with a plurality of waveguides 20.

The plasma-generation system 14 comprises an entry tube 40 having a first end 42 designed to receive the microwaves generated by the microwave generator 18 and a second end 44, and a plurality of waveguides 20, each waveguide 20 having its first end 32 connected to the second end 44 of the waveguide 20 to receive the microwaves propagating in the entry tube 40.

The first end 32 of each waveguide 20 is for example connected to the entry tube 40 by a power divider 46. The power divider 46 is a branched pipe comprising an entry branch 48 connected to the second end 44 of the entry tube 40 and a plurality of exit branches 50, each exit branch 50 being connected to a waveguide tube 28.

As illustrated on FIG. 5, the plasma-generation system 14 comprises two waveguides 20, and the power divider 46 comprises two exit branches 50. The power divider 46 is in the form of a “T”.

Preferably, the waveguides 20 have the same cross section, and the entry tube 40 and each branch of the power divider 46 (i.e. the entry branch 48 and each exit branch 50) have the same cross section as the waveguides 20.

Each waveguide 20 comprises one or more passages 22 for the plasmagenic gas to pass through the waveguides 20 and for the generation of a plasma jet 16. Each passage 22 is connected to the gas-supply device 36 (not shown on FIG. 4) for supply thereof with plasmagenic gas.

Advantageously, each waveguide 20 comprises a plurality of passages 22 distributed along the waveguide 20.

On FIG. 5, each waveguide 20 comprises three passages 22. The passage 22 closest to the second end 34 of the waveguide 20 is located at a distance λ/4 from this second end 34, the following passage 22 is located at a distance λ/4+λ/2 from this second end 34, and the following passage 22 is located at a distance λ/4+λ from this second end 34.

In possible variants, each waveguide 20 has a different number of passages 22, for example one passage 22, two passages 22, four passages 22 or more.

The plasma-generation system 14 comprises for example a pair of waveguides 20 collinear in a distribution direction DD. This makes it possible to have a large number of passages 22 distributed along the distribution direction DD.

In operation, the microwave generator 18 generates microwaves entering the waveguide 20 via the first end 42 of the entry tube 40 and propagating in each waveguide 20 via the power divider 46. The gas-supply device 36 supplies each passage 22 with gas, in particular with air. In each passage 22, the gas passing through the passage 22 is ionised by the microwaves and a plasma jet 16 is generated at the exit 26 of the passage 22.

The provision of a plurality of passages 22 along a waveguide 20 and/or of a plurality of waveguides 20 makes it possible to treat a plurality of regions in one and the same passage.

The configuration in the rough shape of a “T” and comprising two collinear waveguides 20 is given by way of example. Other configurations are possible, for example a configuration in the rough form of an “L”, in comb form or in rake form.

The microwaves used for generating the plasma have for example a frequency of between 300 MHz and 300 GHZ, in particular a frequency of between 2.4 GHz and 2.5 GHZ.

The microwaves used for generating the plasma thus have a wavelength of between 1 mm and 1 m, in particular a wavelength of between 17 cm and 18 cm.

When a waveguide 20 has a rectangular cross-section, the latter has for example a height of between 5 mm and 75 mm, in particular between 42 mm and 44 mm, and/or a width between 10 mm and 150 mm, in particular between 84 mm and 88 mm.

In one example embodiment, the microwaves have a frequency of between 2.4 GHZ and 2.5 GHZ and/or each waveguide 20 has a rectangular cross-section having a height of 43 mm and a width of 86 mm.

In this case, when a plurality of passages are provided along a waveguide 20, the separation between one plasma jet 16 and the following one is a multiple of the half-wavelength in the guide (approximately 8.7 cm), which makes it possible to obtain a value corresponding to a normal separation between plantation rows.

Other plasma-generation systems 14 can be envisaged.

In one example, as illustrated on FIG. 6, a plasma-generation system 14 by microwaves is of the torch type.

The plasma-generation system 14 comprises for example a microwave generator 18 configured to generate microwaves and a waveguide 20 configured to guide the microwaves generated by the microwave generators 18, the waveguide 20 having a passage 22 passing through the waveguide 20 and having an entry 24 and an exit 26, and a torch 51 extending in the passage 22 while passing through the waveguide 20, a space being provided between the torch 51 and the internal wall 24A, 26A of each of the entry 24 and exit 26.

The gas-supply device 36 is connected to the torch 51 to supply the torch 51 with plasmagenic gas, the plasmagenic gas being for example air, and the plasmagenic gas preferably being compressed.

The waveguide 20 comprises a first end 32 designed to receive the microwaves generated by the microwave generator 18 and a second end 34 closed by a short-circuit plug 52—also called “short-circuit”.

Preferably, the short-circuit plug 52 is inserted in the waveguide 20 while being able to slide in the waveguide 20 in such a way that the position of the plug 52 in the waveguide 20 is adjustable.

The entry 24 of the passage 22 is provided with an initiator plug 54—also called an “initiator”—through which the torch 51 extends.

Preferably, the initiator plug 54 is inserted in the entry 24 of the passage 22 while being able to slide in the entry 24 of the passage 22 in such a way that the position of the initiator plug 54 in the entry 24 of the passage 22 is adjustable.

The torch 51 and the waveguide 20 are preferably metal, and the plasma-generation system 14 comprises a voltage generator 56 configured to apply an electrical voltage between the torch 51 and the waveguide 20.

In operation, the microwave generator 18 generates microwaves propagating in the waveguide 20, and the gas-supply device supplies the torch 51 with plasmagenic gas. The plasmagenic gas is ionised by the microwaves propagating in the waveguide 20, and a plasma jet 16 is thus generated at the outlet of the torch 51.

Adjusting the position of the short-circuit plug 52 and/or adjusting the position of the initiator plug 54 makes it possible to modify the propagation of the microwaves in the waveguide 20 to ensure generation of the plasma jet 16 at the outlet of the torch 51.

The weeding device 4 comprises one or more plasma-generation systems 14 of this type.

In particular, a plurality of plasma-generation systems 14 can be arranged to generate plasma jets 16 distributed along a distribution direction DD as mentioned above.

In a variant or in an optional supplement, the plasma-generation system 14 is configured to generate at least one plasma jet by discharge, in particular by bare-electrode discharge, by single dielectric barrier discharge or by double dielectric barrier discharge.

In one example, the weeding device 4 comprises at least one discharge plasma generation system 14, in particular a system 14 for generating plasma by single dielectric barrier discharge, by double dielectric barrier discharge or by bare-electrode discharge.

As illustrated on FIG. 7, a system 14 for generating plasma by bare-electrode discharge comprises a pipe 60 having a first end 62 connected to the gas-supply device 36 for supply thereof with plasmagenic gas and a second end 64 where the plasma is generated in operation, and an electrode 66, preferably filiform, extending in the pipe 60 and terminating in proximity to the second end 64, and a voltage generator 68 connected to the electrode 66 for applying thereto an electrical voltage. Plasmagenic gas circulating in the pipe 60 is in contact with the electrode 66.

In operation, the gas-supply device 36 supplies the pipe with plasmagenic gas and the voltage generator 68 applies a voltage to the electrode 66, which generates an electric field around the electrode 66, the plasmagenic gas passing through this electric field while being ionised, so that the plasma jet 16 is generated at the exit of the pipe 60.

Other systems 14 for generating plasma by bare-electrode discharge can be envisaged.

As illustrated on FIG. 8, a system 14 for generating plasma by single dielectric barrier discharge differs from the system 14 for generating plasma by bare-electrode discharge of FIG. 5 in that the electrode 66 constitutes a first electrode, the plasma-generation system 14 comprising a second electrode 70 located outside the pipe 60, here around the second end 64 of the pipe 60, the voltage generator 68 being connected to the two electrodes 66, 70 for generating an electrical voltage between the two electrodes 66, 70.

The pipe 50 is produced from a dielectric material. Plasmagenic gas circulating in the pipe 60 is in contact with the electrode 66 and is not in contact with the electrode 70.

In operation, the gas-supply device 36 supplies the pipe 60 with plasmagenic gas and the voltage generator 68 applies a voltage between the two electrodes 66, 70, which generates an electric field between the two electrodes 66, 70, the plasmagenic gas passing through this electric field while being ionised, so that the plasma jet 16 is generated at the exit of the pipe 60.

Other systems 14 for generating plasma by single dielectric barrier discharge can be envisaged.

As illustrated on FIG. 9, a system 14 for generating plasma by double dielectric barrier discharge differs from the system 14 for generating plasma by bare-electrode discharge of FIG. 6 in that the first electrode 66 is separated from the gas flow by a dielectric material. The first electrode 66 is here covered by a dielectric material 71.

Plasmagenic gas circulating in the pipe 60 is not in contact with the first electrode 66 and the second electrode 70.

In operation, the gas-supply device 36 supplies the pipe 60 with plasmagenic gas and the voltage generator 68 applies a voltage between the two electrodes 66, 70, which generates an electric field between the two electrodes 66, 70, the plasmagenic gas passing through this electric field while being ionised, so that the plasma jet 16 is generated at the exit of the pipe 60.

Other systems 14 for generating plasma by double dielectric barrier discharge can be envisaged.

The weeding device 4 comprises one or more discharge plasma-generating systems 14.

In particular, a plurality of discharge plasma-generation system 14 can be arranged to generate plasma jets 16 distributed along a distribution direction DD, as mentioned above.

In one example, the weeding device 4 comprises a system 14 for generating plasma by double dielectric barrier discharge using the unwanted plants as one of the dielectric barriers, to generate a plasma in a layer of air located between an electrode and the ground 8.

As illustrated on FIG. 10, such a plasma-generation system 14 comprises for example a power electrode 72 configured to be disposed above the ground, a dielectric layer 74 disposed under the t power electrode 72, and a voltage generator 76 configured to apply a voltage between the ground and the power electrode 72 so as to ionise the layer of air located between the ground and the power electrode 72.

In operation, the voltage generator 76 applies a voltage between the ground and the power electrode 72 so as to ionise the layer of air located between the ground and the power electrode 72. The power electrode 72 is separated from the ground by the dielectric layer 74 and by the unwanted plants, which define another dielectric layer.

Such a plasma-generation system 14 makes it possible to effectively weed a large surface of the ground.

The weeding devices 4 and the plasma-generation systems 14 described above make it possible to implement a weeding method comprising generating a plasma from a plasmagenic gas and exposing unwanted plants to the plasma to eliminate these unwanted plants.

Preferably, the plasmagenic gas used for generating the plasma is compressed. Advantageously, the plasmagenic gas is not exclusively air, in particular compressed air.

Generating a plasma comprises for example generating at least one plasma jet, each plasma jet 16 having for example the form of a column or a curtain.

The weeding method advantageously comprises generating a plurality of plasma jets 16 spaced apart from one another in a distribution direction DD, the plasma jets 16 preferably being spaced apart uniformly, with a constant pitch between the plasma jets in the distribution direction DD.

In this case, the weeding method preferably comprises moving the plasma jets 16 along plantation rows extending in a planting direction, the distribution direction DD being perpendicular to the planting direction, each plasma jet 16 being located facing an inter-row of the planting.

The weeding method comprises for example generating at least one plasma jet 16 by ionising the plasmagenic gas by means of microwaves.

Generating at least one plasma jet comprises generating microwaves in at least one elongate waveguide 20 between a first end 32 designed to receive the microwaves and a closed second end 34 and, for each waveguide 20, circulating a flow of plasmagenic gas in at least one passage 22 passing through the waveguide 20 transversely, a plasma jet 16 being formed at the exit of each passage 22.

Each passage 22 is located at a distance from the second end of the waveguide tube that is substantially equal to λ/4+N*λ/2 where λ is the wavelength of the microwaves in the guide and N is a natural integer number equal to or greater than zero.

The weeding method comprises for example supplying microwaves to a plurality of waveguides 20 from microwave generator 18, the first ends 32 of the waveguides 20 being connected to respective exit branches of a branched power divider 46 by means of which the waveguides 20 receive the microwaves.

In a variant or as an optional supplement, as illustrated on FIGS. 7 to 9, according to the weeding method, at least one plasma jet 16 is generated by discharge, in particular by bare-electrode discharge, by single dielectric barrier discharge or by double dielectric barrier discharge.

In a variant or as an optional supplement, as illustrated on FIG. 10, the weeding method comprises generating a plasma by ionising a layer of air located above the ground. The ionisation is implemented for example by means of a power electrode 72 positioned above the ground, a dielectric layer 74 being located under the power electrode 72, by applying a voltage between the power electrode 72 and the ground.

A plasma can be produced easily, for example using the ambient air as gas for generating the plasma, which avoids having to transport a reserve of gas.

The use of a plasma combines the effects of other weeding methods, namely thermal effects (heat), chemical effects (formation of active species such as ozone), and radiating effects (emission of UV light, emission of infrared light). Using a plasma therefore enables effective weeding.

A plurality of plasma jets can be generated simultaneously, for example by means of microwaves and/or by discharge, to implement inter-row weeding in a plantation.

1. A weeding method comprising generating a plasma from a plasmagenic gas and exposing unwanted plants to the plasma to eliminate said unwanted plants.

2. The weeding method according to claim 1, wherein the plasmagenic gas is air.

3. The weeding method according to claim 1, wherein the plasmagenic gas is compressed.

4. The weeding method according to claim 1, wherein generating a plasma comprises generating at least one plasma jet.

5. The weeding method according to claim 4, wherein each of the at least one plasma jet is in the form of a column or a curtain.

6. The weeding method according to claim 4, comprising generating a plurality of plasma jets spaced apart from each other in a distribution direction.

7. The weeding method according to claim 6, wherein the plasma jets are spaced apart uniformly, with a constant pitch between the plasma jets in the distribution direction.

8. The weeding method according to claim 6, comprising moving the plasma jets along plantation rows extending in a plantation direction, the distribution direction being perpendicular to the plantation direction, each plasma jet being located facing an inter-row of the plantation.

9. The weeding method according to claim 1, comprising generating at least one plasma jet by ionisation of the plasmagenic gas by means of microwaves.

10. The weeding method according to claim 1, wherein generating at least one plasma jet comprises generating microwaves in an elongate waveguide between a first end designed to receive the microwaves and a closed second end, and circulating a flow of plasmagenic gas in one or more passages passing through the waveguide transversely, a respective plasma jet being formed at the exit of each passage.

11. The weeding method according to claim 10, wherein each passage is located at a distance from the second end of the waveguide tube that is substantially equal to λ/4+N*λ/2 where λ is the wavelength of the microwaves in the guide and N is a natural integer number equal to or greater than zero.

12. The weeding method according to claim 10, wherein a plurality of waveguides are connected to respective exit branches of a branched power divider by means of which the waveguides receive the microwaves.

13. Weeding method according to claim 1, wherein at least one plasma jet is generated by discharge, in particular by bare-electrode discharge, by single dielectric barrier discharge or by double dielectric barrier discharge.

14. The weeding method according to claim 1, comprising generating a plasma by ionising a layer of air located above the ground.

15. The weeding method according to claim 14, wherein ionisation is implemented by means of a power electrode positioned above the ground, a dielectric layer being located under the power electrode, by applying a voltage between the power electrode and the ground.

16. A weeding device comprising a plasma-generation system configured to generate a plasma from a plasmagenic gas.

17-22. (canceled)

23. The weeding device according to claim 16, configured to generate at least one plasma jet from microwaves, comprising a microwave generator configured to generate microwaves in at least one elongate waveguide between a first end designed to receive the microwaves and a closed second end, each waveguide having at least one passage passing through the waveguide transversely, and a supply device configured to supply each passage with a flow of plasmagenic gas for generating a respective plasma jet at the exit of each passage when the microwave generator generates microwaves in the waveguide.

24. The weeding device according to claim 23, wherein each passage of each waveguide is located at a distance from the second end of the waveguide that is substantially equal to λ4+N*λ/2 where λ is the wavelength of the microwaves in the guide and N is a natural integer number equal to or greater than zero.

25. The weeding device according to claim 23, wherein a plurality of waveguides are connected to respective exit branches of a branched power divider by means of which the waveguides receive the microwaves.

26. (canceled)

27. The weeding device according to claim 16, configured to generate a plasma by ionising a layer of air situated above the ground; and
wherein the ionisation is implemented by means of a power electrode positioned above the ground, a dielectric layer being located under the power electrode, and by applying a voltage between the power electrode and the ground.

28. (canceled)
